(19) United States
(12) Patent Application Publication
(10) Pub. No.: US 2007/0185219 A1
(43) Pub. Date: Aug. 9, 2007

(54) Method of Breaking Aqueous Heavy Crude Emulsions by Adding Polar Solvents

(76) Inventors: Jean-Francois Argillier, Saint-Cloud (FR); Isabelle Henaut, Rueil-Malmaison (FR); Charlotte Desquesnes, Beaumetz (FR); Martin Fessard, Paris (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/611,942

(22) Filed: Dec. 18, 2006

(30) Foreign Application Priority Data
Dec. 21, 2005 (FR) 05/13.063

(51) Int. Cl. B01D 17/05

(52) U.S. Cl. 516/141; 516/185; 516/189

(57) ABSTRACT

The present invention relates to a method of breaking an oil-in-water emulsion, the oil essentially consisting of a heavy hydrocarbon, i.e. having a viscosity above approximately 100 centipoise at ambient temperature. According to the invention, at least one solvent defined by: a polar coefficient according to the Hansen classification above 5, a “hydrogen” coefficient according to the Hansen classification below 16, is added to the emulsion.

### FIELD OF THE INVENTION

The invention mainly relates to the sphere of the development of heavy petroleum crudes wherein the effluent produced and/or transported is in form of an oil-in-water emulsion. The object of the present invention is to provide a method allowing to “break” the heavy crude emulsion in an aqueous continuous phase, i.e. to separate the different phases thereof.

### BACKGROUND OF THE INVENTION

Owing to their currently known amount, heavy crude hydrocarbons (defined by a density below 20° API at ambient temperature) are a considerable hydrocarbon reserve nearly identical to conventional oils reserve. However, because of their high viscosity, development of these petroleum products remains technically difficult. Under reservoir conditions, these crudes generally have viscosities at least above 100 centipoise. What is referred to as heavy crudes also includes extra-heavy crudes, notably bitumen. The present invention also applies to aqueous residue emulsions that can be obtained after refining, for example atmospheric distillation or vacuum residues.

The aqueous emulsions to be processed can form in some cases in the reservoir (for example by the SAGD—Steam Assisted Gravity Drainage—process), at the drain hole bottom or at the wellhead, or they can be created to facilitate transportation through pipes.

In fact, a known technique currently used to facilitate heavy oils transportation consists in forming them into an aqueous emulsion. Direct emulsification of a heavy crude consists in dispersing it in form of droplets in water in order to reduce the viscosity thereof. It is an efficient technique for reducing the viscosity of these petroleum products and for making it compatible with pipeline transportation requirements [Rimmer D., Greogoli A., Hamshar J., Yildirim E., “Pipeline emulsion transportation for heavy oils”, in L.L. Schramm (Ed.), Emulsions Fundamentals and Applications in the Petroleum Industry, American Chemical Society, Washington D.C., chapter 8, 295-312,1992]. There are various stabilized emulsion formulation possibilities: addition of a base to allow in-situ activation of the natural surfactants contained in the crude, addition of hydrophilic type surfactants, high proportion of water. They lead to low-viscosity, very stable emulsions that can contain up to 70% volume of crude.

These emulsions, stable by definition, require the use of a phase separation method during one of the stages of the industrial hydrocarbon value chain.

### SUMMARY OF THE INVENTION

The present invention thus provides a method of breaking an oil-in-water emulsion, said oil essentially consisting of a heavy hydrocarbon, i.e. having a viscosity above approximately 100 centipoise at ambient temperature. According to the invention, at least one solvent defined by:
a polar coefficient according to the Hansen classification above 5,
a “hydrogen” coefficient according to the Hansen classification below 16, is added to said emulsion.

The solvent can be defined by a polar coefficient above 6 and a hydrogen coefficient below 8.

The boiling-point temperature of said solvent can range between 50° C. and 180° C., preferably between 80° C. and 120° C.

A volume of solvent at least above 1 ml can be added to 10 ml emulsion.

A proportion of naphtha ranging between 1% and 50% can be added to dilute the emulsion prior to adding the breaking solvent.

The solvent can have a preferential miscibility with the hydrocarbon.

An amount of salt can be added to increase the breakup efficiency.

An amount of salt ranging between 0.1 and 1 g NaCl can be added to 10 ml emulsion.

The solvent can be separated by distillation and recycled.

The invention also relates to the application of the method to a process for transporting a heavy hydrocarbon by oil-in-water emulsion, to separate the oil and aqueous phases.

After pipeline transportation, an emulsion destabilization stage comprising an emulsion thermal treatment stage and the emulsion breakup stage according to the invention can be carried out.

The emulsion thermal treatment stage and the emulsion breakup stage can be joint stages.

### BRIEF DESCRIPTION OF THE FIGURES

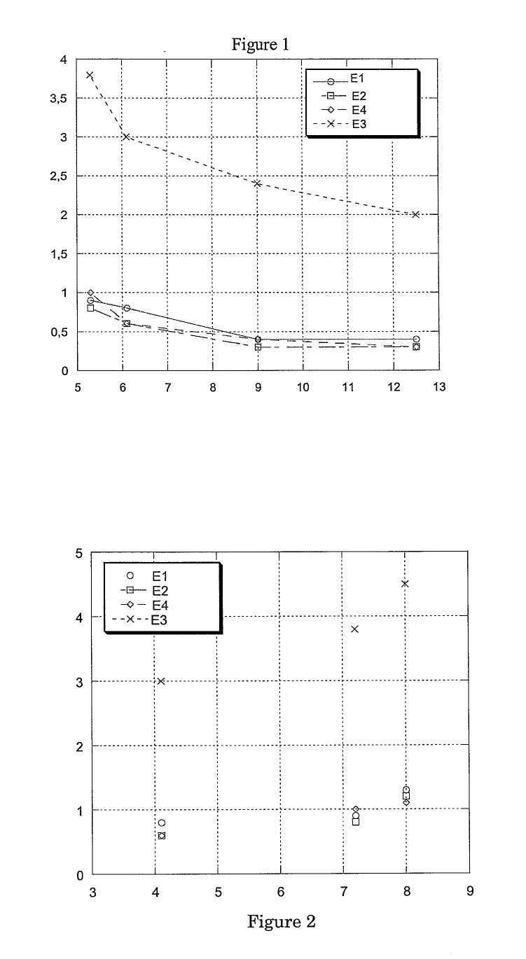

Other features and advantages of the present invention will be clear from reading the description hereafter of non limitative examples, illustrated by FIGS. 1 and 2 that respectively show breakup results using solvents defined according to the Hansen polar coefficients and according to the Hansen “hydrogen” coefficients.

### DETAILED DESCRIPTION

Definition and Operating Method of Preparation of the Various Emulsions Tested:

The tests were carried out on two heavy crudes: Sincor crude (° API=8.5, I₅=17% according to the D6560/IP143 ASTM standard) and Merey crude (° API=16, I₅=17.5% according to the D6560/IP143 ASTM standard).

1) Emulsion E1 with NH₄OH (1 g/l):

105 ml Sincor (or Merey) crude heated to 80° C. are mixed with 45 ml MilliQ water containing 1 g/l NH₄OH heated to 60° C. (volume ratio 70/30). The mixture is stirred for 5 minutes by an Ultraturax at 13,000 rpm. The emulsion then slowly cools down to the ambient temperature.

2) Emulsion E2 with KOH at pH=12:

105 ml Sincor crude heated to 80° C. are mixed with 45 ml MilliQ water whose pH value is adjusted to 12 with KOH heated to 60° C. (volume ratio 70/30). The mixture is stirred for 5 minutes by an Ultraturax at 13,000 rpm. The emulsion then slowly cools down to the ambient temperature.

N.B.: In order to come close to real conditions, some potash emulsions are prepared by replacing the distilled water by tap water and salt water (NaCl) at 10 g/l.

3) Emulsion E3 with Triton-X405 (1% by mass) from the FLUKA Company:

105 ml Sincor (or Merey) crude heated to 80° C. are mixed with 45 ml MilliQ water containing 1% by mass Triton-X405 heated to 60° C. (volume ratio 70/30). The mixture is stirred for 5 minutes by an Ultraturax at 13,000 rpm. The emulsion then slowly cools down to the ambient temperature.

4) Emulsion E4 with SDS (1% by mass) from the VWR Company:

105 ml Sincor crude heated to 80° C. are mixed with 45 ml MilliQ water containing 1% by mass of SDS heated to 60° C. (volume ratio 70/30). The mixture is stirred for 5 minutes by an Ultraturax at 13,000 rpm. The emulsion then slowly cools down to the ambient temperature.

All these emulsions are globally stable over long periods (several days). Creaming phenomena can sometimes be observed, but simple stirring allows the emulsion to recover its initial characteristics. This creaming phenomenon is more often observed on “basic” emulsions than on emulsions stabilized by a surfactant.

On the other hand, prolonged centrifugation (3 hours at 11,800 rpm) of such emulsions does not lead to total phase separation, the water content of the organic phase remaining always much higher than 20% by mass. Similarly, addition of a large amount of salt (NaCl) to the emulsion does not sufficiently destabilize the emulsion to cause breakup thereof.

Typical Breakup Test Protocol and Breakup Characterization:

The protocol used to study the emulsion breakup using various solvents is as follows:
10 ml emulsion is placed in a 50-ml centrifuging tube,
the emulsion is stirred for 2 minutes using a magnetic agitator,
prior to solvent addition, the emulsion can be, depending on the various tests, pre-diluted by adding 0.6 ml naphtha. Salt can be added: typically 0.2 g NaCl according to the tests. The solvent selected is then added. Unless otherwise stated, 1.4 ml solvent is then added to the emulsion,
the tube is then vortexed for 10 seconds, it is stirred for 10 more seconds using the magnetic agitator, then again vortexed for 10 seconds,
the tube is then placed in a centrifuge at 11,800 rpm for 3 hours.

After passage through the centrifuge, 2 phases are generally recovered:
an aqueous phase (aqueous continuous phase possibly containing a residual oil proportion) that is recovered by means of a 5-ml syringe. The volume of aqueous phase collected is measured and its “cleanness” and its colour are assessed,
an organic phase (major organic phase possibly containing a residual water proportion). The water content (percent by mass) of this organic phase is measured by means of the Karl Fischer method.

Characterization of the breakup efficiency is given qualitatively by means of the proportion of water recovered, but it is better quantified by the residual water content of the organic phase determined by means of the Karl Fischer method.

Emulsion Breaking Solvents:

The Hansen classification is used to select, according to the invention, the solvents (or solvent mixtures).

The Hansen parameters (Hansen, C. M. , The universality of the solubility parameter, Ind. Eng. Chem. Prod. Res. Dev., 8, 2, 1969.) are an extension of the Hildebrand parameter (Hildebrand, J. H., and Scott, R. L., Solubility of Non-Electrolytes, 3^{rd} ed. Reinhold, N.Y., 1950; Dover, N.Y., 1964.). They are related thereto by the relation

$${δ}_{t}^{2} = {δ}_{d}^{2} + {δ}_{p}^{2} + {δ}_{h}^{2}$$

wherein □ₜ corresponds to the Hildebrand parameter, □_{d} corresponds to the dispersion forces, □ₚ to the polar component and □ₕ to the contribution of the hydrogen bonds.

In the case of a mixture S of n solvents S₍ᵢ₎ (i=1,n) in volume proportions V₍ᵢ₎ (i=1,n), with

$${\sum }_{i = 1}^{i = n} {V}_{( i )} = 1 ,$$

the Hansen parameters of this mixture of solvents S are:

$${δ}_{d} = {\sum }_{i = 1}^{i = n} ( {δ}_{d ( i )} \times {V}_{i} )$$

$${δ}_{p} = {\sum }_{i = 1}^{i = n} ( {δ}_{p ( i )} \times {V}_{i} )$$

$${δ}_{h} = {\sum }_{i = 1}^{i = n} ( {δ}_{h ( i )} \times {V}_{i} )$$

The petroleum hydrocarbons commonly used to dilute the heavy crudes have Hansen parameters whose polar component is low, typically below 0,8 (MPa)^{1/2}. For example, for the ASTM ‘B’ fuel: □ₚ is 0,4 (MPa)^{1/2} (Allan F. M. Barton, Handbook of Solubility Parameters and Other Cohesion Parameters, CRC Press, 1991).

We have selected the breaking additives in the following list:

| Solvents | δd | δp | δh | Total | Boiling-point T (° C.) | Density (g/cm3) at 20° C. |
|---|---|---|---|---|---|---|
| Ethanol | 15.8 | 8.8 | 19.4 | | 78.5 | 1.36 |
| Butyronitrile | 15.3 | 12.5 | 5.1 | 20.4 | 116-118 | 0.8 |
| MEK | 16 | 9 | 5.1 | 19 | 79.6 | 0.8 |
| MIBK | 15.3 | 6.1 | 4.1 | 17 | 116 | 0.8 |
| THF | 16.8 | 5.7 | 8 | 19.4 | 67 | 1.4 |
| Ethyl acetate | 15.8 | 5.3 | 7.2 | 18.1 | 77 | 0.9 |
| Heptane | 15.3 | 0 | 0 | 15.3 | 98 | 0.68 |

### EXAMPLE 1

Basic emulsion E1 Sincor-NH3 (1 g/l): Influence of the solvent polarity

The breakup results with the various solvents are given in the tables hereunder. In this test, 10 ml emulsion were pre-diluted by addition of 0.6 ml naphtha and 0.2 g NaCl were added. It can be noted that the reference test that consists in adding no solvent (10 ml emulsion+0.6 ml naphtha+0.2 g salt+centrifugation) results in a very bad breakup since 0.6 ml aqueous phase is recovered and the water content of the residue is above 20%.

Qualitative analysis of the aqueous phase:

| | Solvent | | | | | | |
|---|---|---|---|---|---|---|---|
| | | | | | Ethyl | | |
| | THF | Butyronitrile | MEK | MIBK | acetate | Ethanol | Heptane |
| Recovered | 3.4 | 3.45 | 3.4 | 3.4 | 3.4 | 4.5 | 1.9 |
| volume (ml) of | | | | | | | |
| aqueous phase | | | | | | | |
| Aspect of the | limpid | limpid | limpid | limpid | limpid | orangey | slightly dirty |
| aqueous phase | | | | | | | |

Water content of the organic phase:

| | Solvent | | | | | | |
|---|---|---|---|---|---|---|---|
| | | | | | Ethyl | Eth- | Hep- |
| | THF | Butyronitrile | MEK | MIBK | acetate | anol | tane |
| % by mass | 1.3 | 0.4 | 0.4 | 0.8 | 0.9 | 8 | >10% |
| of water | | | | | | | |

### EXAMPLE 2

Basic Emulsion E2 Sincor-KOH (pH=12): Influence of the Solvent Polarity

The breakup results with the various solvents are given in the tables hereunder. In this test, 10 ml emulsion were pre-diluted by addition of 0.6 ml naphtha and 0.2 g NaCl were added. It can be noted that the reference test that consists in adding no solvent (10 ml emulsion+0.6 ml naphtha+0.2 g salt+centrifugation) results in a very bad breakup since 0.5 ml aqueous phase (quite limpid) is recovered and the water content of the residue is above 20%.

Qualitative analysis of the aqueous phase:

| | Solvent | | | | | | |
|---|---|---|---|---|---|---|---|
| | | | | | Ethyl | | |
| | THF | Butyronitrile | MEK | MIBK | acetate | Ethanol | Heptane |
| Recovered | 3.4 | 3.45 | 3.45 | 3.4 | 3.4 | 4.1 | 1.8 |
| volume (ml) of | | | | | | | |
| aqueous phase | | | | | | | |
| Aspect of the | limpid | limpid | limpid | limpid | limpid | orangey | slightly dirty |
| aqueous phase | | | | | | | |

Water content of the organic phase:

| | Solvent | | | | | | |
|---|---|---|---|---|---|---|---|
| | | | | | Ethyl | | Hep- |
| | THF | Butyronitrile | MEK | MIBK | acetate | Ethanol | tane |
| % by | 1.2 | 03 | 0.3 | 0.6 | 0.8 | 11 | >10% |
| mass of | | | | | | | |
| water | | | | | | | |

### EXAMPLE 3

Emulsion E4 Sincor in 1% Mass SDS Water: Influence of the Solvent Polarity

The breakup results with the various solvents are given in the tables hereunder. In this test, 10 ml emulsion were pre-diluted by addition of 0.6 ml naphtha and 0.2 g NaCl were added. It can be noted that the reference test that consists in adding no solvent (10 ml emulsion+0.6 ml naphtha+0.2 g salt+centrifugation) results in a very bad breakup since 0.6 ml aqueous phase is recovered and the water content of the residue is above 20%.

Qualitative analysis of the aqueous phase:

| | Solvent | | | | | |
|---|---|---|---|---|---|---|
| | | | | | Ethyl | Hep- |
| | THF | Butyronitrile | MEK | MIBK | acetate | tane |
| Recovered | 3.3 | 3.3 | 3.3 | 3.3 | 3.3 | 1.8 |
| volume of | | | | | | |
| aqueous | | | | | | |
| phase (ml) | | | | | | |

| | |
|---|---|
| Aspect of the | Transparent yellow |
| aqueous phase | |

Water content of the organic phase:

| | Solvent | | | | | |
|---|---|---|---|---|---|---|
| | THF | Butyronitrile | MEK | MIBK | Ethyl acetate | Heptane |
| % by mass | 1.1 | 0.3 | 0.4 | 0.6 | 1 | >10% |
| of water | | | | | | |

### EXAMPLE 4

Emulsion E3 Sincor in 1% Mass Triton X405 Water: Influence of the Solvent Polarity

The breakup results with the various solvents are given in the tables hereunder. In this test, 10 ml emulsion were pre-diluted by addition of 0.6 ml naphtha and 0.2 g NaCl were added. It can be noted that the reference test that consists in adding no solvent (10 ml emulsion+0.6 ml naphtha+0.2 g salt+centrifugation) results in a very bad breakup since the water content of the residue is above 20%.

Qualitative analysis of the aqueous phase:

| | Solvent | | | | | |
|---|---|---|---|---|---|---|
| | | | | | Ethyl | |
| | THF | Butyronitrile | MEK | MIBK | acetate | Heptane |
| Recovered | 3.2 | 3.3 | 3.3 | 3.2 | 3.3 | 1.4 |
| volume (ml) of | | | | | | |
| aqueous phase | | | | | | |
| Aspect of the | dirty | dirty | dirty | dirty | dirty | dirty |
| aqueous phase | | | | | | |

Water content of the organic phase:

| | Solvent | | | | | |
|---|---|---|---|---|---|---|
| | | | | | Ethyl | |
| | THF | Butyronitrile | MEK | MIBK | acetate | Heptane |
| % by mass of | 4.5 | 2 | 2.4 | 3 | 3.8 | >15% |
| water | | | | | | |

FIG. 1 shows in ordinate the mass percentage of water in the organic phase as a function of the Hansen polar coefficients of the additives tested on emulsions E1, E2, E3 and E4: ethyl acetate, MIBK, MEK, butyronitrile.

It is clear in this figure that the higher the Hansen polar coefficient, the more efficient the solvent is as the breaking agent.

Analysis of the results obtained with MIBK, ethyl acetate and THF shows in FIG. 2 that, with close polar coefficients, the higher the Hansen “hydrogen” coefficient, the lower the breakup efficiency. FIG. 2 shows in ordinate the mass percentage of water in the organic phase as a function of the Hansen “hydrogen” coefficients of the additives tested on emulsions E1, E2, E3 and E4, respectively from left to right for: MIBK, ethyl acetate and THF.

These effects are also confirmed when comparing MEK (good results) and ethanol (bad results).

### EXAMPLE 5:

Influence of the Volume of Solvent Added: Emulsion E1 Sincor-NH3 (1 g/l) and Breakup with MEK

The tests were carried out by adding to 10 ml of an ammonia (1 g/l) emulsion 0.2 g salt and a variable volume of MEK. The tube is then vortexed for 10 seconds, it is stirred for 10 more seconds with a magnetic agitator, then again vortexed for 10 seconds. The tube is then placed for 3 hours in a centrifuge at 11,800 rpm.

The results characterizing the water content of the organic phase are given in the table hereafter:

| | Volume of MEK | | |
|---|---|---|---|
| | added (ml) | | |
| | 0.5 | 1 | 2 |
| % by mass of water | 20 | 7 | 0.4 |

These results show that a minimum volume of solvent is required to obtain a good breakup quality.

### EXAMPLE 6

Influence of the Mixture Composition: Emulsion E1 Sincor-NH3 (1 g/l)

The tests were carried out by adding to 10 ml of an ammonia (1 g/l) emulsion 0.2 g salt and 2 ml of a MEK/naphtha mixture of variable ratio (the volume fraction of MEK in the mixture ranges from 0. 1 to 1). As above, the tube is then vortexed for 10 seconds, it is stirred for 10 more seconds with a magnetic agitator, then again vortexed for 10 seconds. The tube is then placed for 3 hours in a centrifuge at 11,800 rpm.

The results characterizing the water content of the organic phase are given in the table hereafter:

Volume fraction of MEK

| | 0.1 | 0.3 | 0.5 | 0.7 | 0.9 | 1 |
|---|---|---|---|---|---|---|
| % by mass of water | 3.2 | 2.3 | 1.2 | 0.4 | 0.4 | 0.4 |

These results show that a minimum volume of MEK in the mixture is required to obtain a good breakup quality.

### EXAMPLE 7

Tests on the Merey Heavy Crude

7. 1: Emulsion E1 Merey- NH₄OH (1 g/l)

The results of the breakup performed under the same conditions as in Example 1 are as follows:

For the aqueous phase:

| | Solvent | | | | |
|---|---|---|---|---|---|
| | THF | Butyronitrile | MEK | Ethyl acetate | Heptane |
| Aqueous phase | 3.4 | 3.45 | 3.45 | 3.4 | 2.3 |
| volume (ml) | limpid | limpid | limpid | limpid | hardly |
| and aspect | | | | | dirty |

For the organic phase:

| | Solvent | | | | |
|---|---|---|---|---|---|
| | THF | Butyronitrile | MEK | Ethyl acetate | Heptane |
| % by mass of water | 0.7 | 0.23 | 0.26 | 0.61 | >10% |

7.2: Emulsion E3 Merey Triton-X405 (1% by mass):

The results of the breakup performed under the same conditions as in Example 4 are as follows:

For the aqueous phase:

| | Solvent | | | | |
|---|---|---|---|---|---|
| | THF | Butyronitrile | MEK | Ethyl acetate | Heptane |
| Aqueous phase | 3.25 | 3.3 | 3.3 | 3.25 | 2.1 |
| volume (ml) | dirty | dirty | dirty | dirty | dirty |
| and aspect | | | | | |

For the organic phase:

| | Solvent | | | | |
|---|---|---|---|---|---|
| | THF | Butyronitrile | MEK | Ethyl acetate | Heptane |
| % by mass of water | 1.19 | 0.13 | 0.14 | 0.48 | >10% |

The reference tests (10 ml emulsion+0.6 ml naphtha+0.2 g salt+centrifugation) were also carried out. The results are as follows:
For the NH3 emulsion, 0.9 ml of a quite dirty aqueous phase is obtained and the water content of the organic phase is >20%,
for the Triton emulsion, 0.8 ml of a quite dirty aqueous phase is obtained and the water content of the organic phase is >20%.

The results obtained on this second crude are in accordance with those obtained with the Sincor crude. These results confirm the good results obtained in particular with MEK and butyronitrile.

### EXAMPLE 8

Influence of the Salt Concentration

2 ml MEK and a variable amount of salt are added to the 10 ml emulsion E1 Sincor-NH3 (1 g/l). The breakup efficiency is characterized by the water content of the crude phase. Low water contents are sought. The results are given in the table hereafter:

| | Added salt content (g) | | | | | | | |
|---|---|---|---|---|---|---|---|---|
| | 0 | 0.01 | 0.05 | 0.1 | 0.2 | 0.3 | 0.4 | 0.5 |
| Salt concentration | 0 | 3.3 | 16.6 | 33 | 66 | 99 | 133 | 166 |
| in relation to the | | | | | | | | |
| water (g/l) | | | | | | | | |
| % by mass of | 1.6 | 1.1 | 0.7 | 0.4 | 0.4 | 0.4 | 0.4 | 0.4 |
| water in the | | | | | | | | |
| organic phase | | | | | | | | |

It can be seen that, over a rather wide salt concentration range, breakup of the emulsion is achieved. If we limit ourselves to the “water content” parameter, it is thus possible to go down to low salt values (much lower than the salt concentration of sea water, which ranges between 25 and 30 g/l, and of conventional formation water).

Concerning the influence of salt on the quality of the water recovered, the following observations can be made: although the salt concentration does not have a significant influence on the volume of aqueous phase recovered, it however influences the quality of the water recovered. In the case of breakup of an ammonia Sincor emulsion with MEK, it is experimentally observed that the shade of the water recovered increases when the ionic strength decreases. Below approximately 50 g/l, the water is limpid and transparent whereas, above 50 g/l, the aqueous phase is no longer limpid and will require later treatment.

### EXAMPLE 9

Influence of the Volume of Solvent Added: Emulsion E1 Sincor-NH3 (1 g/l) and breakup with MEK/naphtha

Different volumes of a MEK/naphtha mixture, with a ratio of 50% by volume, are added to the 10 ml emulsion (Sincor-NH3 1 g/l), without adding salt. The breakup efficiency is characterized by the water content of the crude phase. The results are given in the table hereunder:

| | Volume of MEK | | |
|---|---|---|---|
| | added (ml) | | |
| | 2 | 5 | 20 |
| % by mass of water | 1.8 | 0.6 | 0.5 |

These results show, as for Test 5, that a minimum volume of solvent is required to obtain a good breakup quality. It is also observed that the limpidity of the water recovered increases with the volume of polar solvent added.

Concerning recycling of the polar solvent, it can be advantageous to have a preferential solubility of the solvent in the hydrocarbon phase and not too high a boiling-point temperature to allow recovery from heavy crude by distillation at a reasonable temperature.

MEK is very interesting in this respect because:—its boiling-point temperature is about 80° C.;—its solubility in water is rather low in the presence of hydrocarbons;—and it decreases when the temperature rises, or when the salt concentration increases. In the case of an industrialized process, it can therefore be advantageous to work at higher temperatures and possibly in the presence of salt (which also improves, as mentioned above, the residual water quality).

The present invention can be jointly applied to other stages of breaking or destabilizing a transported crude emulsion. Examples thereof are notably the crude emulsion transportation method described in document FR-2,842,886 comprising an oil-in-water emulsion preparation stage, an emulsion pipeline transportation stage, an emulsion destabilization stage, using notably heating, an emulsion breakup stage, followed by a stage of separation of the oil and aqueous phases. The breakup stage and/or the destabilization stage can comprise the method according to the invention. After the phase separation stage, a stage of recovery of the polar solvent(s) used can be necessary, by distillation for example.

In a variant, it is possible to carry out addition of the polar solvent according to the invention to said emulsion and to heat according to a suitable procedure so as to both break the emulsion and recover one of the emulsifying products, ammonia for example. This variant is described by means of the following examples.

Preparation of the Various Emulsions Tested

105 ml Sincor (or Merey) crude heated to 80° C. are mixed with 45 ml MilliQ water containing 1 g/l NH₄OH heated to 60° C. (volume ratio 70/30). The mixture is stirred for 5 minutes by an Ultraturax at 13,000 rpm. The emulsion then slowly cools down to the ambient temperature.

The protocols used to study the emulsion breakup by coupling the temperature and the addition of polar solvent are as follows:
Protocol 1 (P1): 50 ml emulsion diluted by 5% (by mass in relation to the initial crude) of naphtha are placed in a 100-ml three-necked bottle. The crude used is Sincor. 10 ml of a polar solvent are then possibly added. The emulsion is heated to 90-95° C. for 1 h 20 min under stirring (using a bar magnet) and stripped (for example with N2) to remove the ammonia from the medium and possibly to recover part of the polar solvent. The water contained in the emulsion is condensed through the action of a cooler. The ammonia is trapped by a 100-ml HCl solution whose pH value is close to 2 or 3. It is thus possible to know, by monitoring the pH value of this solution, the amount of NH3 separated. After 1 h 20 min, stripping, stirring and heating are stopped. The medium is left to cool down at the same time as the water bath.
Protocol 2 (P2): After placing the emulsion diluted by the naphtha and the polar solvent in the three-necked bottle, a temperature ramp (from 25° C. to 90° C. within about 30 minutes) is achieved, during which the emulsion is stripped with N2. Then, it is kept at 90° C. for about 1 h 30 min, without bubbling, but stirring is maintained, then the emulsion is left to cool down.

After the breakup treatment, two phases are generally recovered:
an aqueous phase (aqueous continuous phase possibly containing a proportion of residual oil),
an organic phase (major organic phase possibly containing a proportion of residual water). The water content (percent by mass) of this organic phase is measured by means of the Karl Fischer method.

Characterization of the breakup efficiency is quantified by the residual water content of the organic phase determined by means of the Karl Fischer method.

All of the results obtained with various solvents added to the diluted emulsion (no solvent (reference), naphtha, MEK) are given in the table hereafter:

| | | Solvent | Water content of the organic | |
|---|---|---|---|---|
| No. | Proto. | (10 ml) | phase (% by mass) | Observations |
| 1 | P1 | MEK | 2.2 | Coloured water |
| 2 | P2 | MEK | 1.4 | Coloured water |
| 3 | P2 | MEK | 1.3 | Coloured water |
| 4 | P2 | Nothing | — | Bad breakup |
| 5 | P2 | Naphtha | — | Bad breakup |

If we compare the results of Tests 1 and 2, we see that protocol P2, characterized by the temperature ramp and the temperature maintenance after stripping stop, gives better results.

Tests 2 and 3, carried out on two different emulsions, show a rather good reproducibility of the tests with protocol P2.

Test 4 shows that, under the testing conditions, the breakup is bad if no solvent is added. Bad breakage means that the water/oil separation is not clear and that it is difficult to characterize the two phases distinctly.

Test 5 shows that the addition of naphtha does not allow to obtain a breakup of good quality.

Tests 1-3, compared with 4,5, show the efficiency of the addition of MEK for breaking the emulsion.

In relation to the breakup tests without thermal treatment, Tests 2 and 3 show an improvement in the breakup, notably with protocol P2.

The ammonia and the MEK can be advantageously recycled in this process owing to their low boiling-point temperature.

1. A method of breaking an oil-in-water emulsion, said oil essentially consisting of a heavy hydrocarbon, i.e. having a viscosity above approximately 100 centipoise at ambient temperature, characterized in that at least one solvent defined by:
a polar coefficient according to the Hansen classification above 5,
a “hydrogen” coefficient according to the Hansen classification below 16, is added to said emulsion.

2. A method as claimed in claim 1, wherein said solvent is defined by a polar coefficient above 6 and a hydrogen coefficient below 8.

3. A method as claimed claim 1, wherein the boiling-point temperature of said solvent ranges between 50° C. and 180° C., preferably between 80° C. and 120° C.

4. A method as claimed in claim 1, wherein a volume of solvent at least above 1 ml is added to 10 ml emulsion.

5. A method as claimed in claim 1, wherein a proportion of naphtha ranging between 1% and 50% is added to dilute the emulsion prior to adding the breaking solvent.

6. A method as claimed in claim 1, wherein said solvent has a preferential miscibility with the hydrocarbon.

7. A method as claimed in claim 1, wherein a proportion of salt is added to increase the breakup efficiency.

8. A method as claimed in claim 1, wherein a proportion of salt ranging between 0.1 and 1 g NaCl is added to 10 ml emulsion.

9. A method as claimed in claim 1, wherein said solvent is separated by distillation and recycled.

10. A method of transporting a heavy hydrocarbon by an oil-in-water emulsion comprising separating an oil phase and an aqueous phase using the method of claim 1.

11. A method of transporting a heavy hydrocarbon by an oil-in-water emulsion, comprising transporting the heavy hydrocarbon by the oil-in-water emulsion and, after pipeline transportation, carrying out an emulsion destabilization stage comprising a stage of thermal treatment of said emulsion and an emulsion breakup stage comprising the method-as claimed in claim 1.

12. Application as claimed in claim 11, wherein said stage of thermal treatment of said emulsion and said emulsion breakup stage are joint stages.
